(19) United States
(12) Patent Application Publication
(10) Pub. No.: US 2007/0211717 A1
(43) Pub. Date: Sep. 13, 2007

(54) System and method for forming an internet protocol to x.25 protocol gateway

(75) Inventors: Richard Capps, Brighton (GB); Mark Mitchell, Bexhill-on-sea (GB); Joanne Lovett, Hove (GB); Janice Burtenshaw, Burgess Hill (GB)

Correspondence Address: FITZPATRICK CELLA (AMEX), 30 ROCKEFELLER PLAZA, NEW YORK, NY, 10112, US

(73) Assignee: American Express Travel Related Services Co., Inc., New York, NY (US)

(21) Appl. No.: 11/436,599

(22) Filed: May 19, 2006

Related U.S. Application Data
(60) Provisional application No. 60/722,406, filed on Oct. 3, 2005.

(51) Int. Cl. H04L 12/56; H04J 3/16

(52) U.S. Cl. 370/389; 370/470; 370/466

(57) ABSTRACT

A system and method for converting an inbound Internet protocol (IP) connection to a X.25 protocol connection such that unmodified legacy X.25 applications can process IP communications.

### CROSS REFERENCE TO RELATED APPLICATIONS

This application claims priority to, and the benefit of, U.S. Provisional Patent Application Ser. No. 60/722,406, filed Oct. 3, 2005, which is hereby incorporated by reference in its entirety.

### BACKGROUND OF THE INVENTION

1. Field of the Invention

The present invention relates generally to the connectivity of chip card terminals and, more particularly, to a system and method for enabling Internet Protocol (IP) connectivity of Point of Sale (POS) terminals currently using the X.25 protocol.

2. Related Art

“EMV” is an acronym often used to mean the specifications issued by EMVCo, LLC covering the operation of Smart card payment cards. Europay International, MasterCard International, and Visa International formed EMVCo, LLC in February of 1999 in order to manage, maintain and enhance the EMV Integrated Circuit Card Specifications for Payment Systems as technology advances and the implementation of chip card programs becomes more prevalent.

EMV chip card terminals are being introduced around the world. Existing terminals generally connect to users using the X.25 protocol, which is an International Telecommunication Union-Telecommunication Standardization Sector (ITU-T) protocol standard for WAN communications that defines how connections between user devices and network devices are established and maintained. There has been for some time, however, a growing tendency on the part of POS and ATM users to request Internet protocol (IP) connectivity, as opposed to X.25.

Accordingly, there is a need for a method to convert inbound IP communications to X.25 communications. That way legacy X.25 applications can be enabled for IP with no modifications, resulting in significant cost savings.

Given the foregoing, what is needed is a system, method and computer program product for forming an Internet Protocol (IP) to X.25 Protocol gateway.

### BRIEF DESCRIPTION OF THE INVENTION

The present invention meets the above-identified needs by providing a system and method for converting Internet Protocol (IP) to X.25 protocol.

An advantage of the present invention is to enable IP connectivity for legacy X.25 applications without the need to make modifications to such applications.

A feature of the present invention is to accept an inbound IP connection and to convert it into a X.25 Virtual Circuit connection. The conversion process may run under the STRATUS® Virtual Operating System (VOS), for example.

Another feature of the present invention marries the two protocols by using a configurable Transport Packet Data Unit (TPDU) length indicator, which allows the conversion process to read the TPDU length indicator in the application buffer. This feature provides the conversion process with a reliable mechanism to connect IP packets logically to form a complete application buffer as required by the X.25 protocol.

Further features of the system and method for converting IP communication data packets to inputs compatible with X.25 protocol software applications, include performing the steps of receiving an IP packet including a TPDU header having a length indicator, reading the length indicator, determining a number of IP data packets required to form a complete IP application buffer based on the read length indicator, forming the complete IP application buffer using the determined number of IP data packets, and outputting the complete IP application buffer for processing by the X.25 protocol software applications.

These features of the present invention solve the problem resulting from the transmission over a network of an application buffer using the IP protocol. During the IP protocol transmission, messages in the buffer may be legitimately fragmented over several packets, causing difficulties in converting such a packet exchange to the X.25 protocol. These difficulties are caused because the X.25 protocol requires a complete message to be received for processing.

Further features and advantages of the present invention, as well as the structure and operation of various embodiments of the present invention, are described in detail below with reference to the accompanying drawings.

### BRIEF DESCRIPTION OF THE DRAWINGS

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a block diagram of an exemplary system environment in which the present invention, in an embodiment, would be implemented.

FIG. 2 is a system diagram illustrating an IP delivery mechanism.

FIG. 3 is a system diagram illustrating a X.25 delivery mechanism.

FIG. 4 is a system diagram illustrating the IP to X.25 conversion problem being solved by the present invention.

FIG. 5 is a pseudocode listing for an IP task according to one embodiment of the present invention.

FIGS. 5A and 5B are examples of a complete IP protocol message buffer.

FIG. 6 is a pseudocode listing for a check_for_input procedure of an IP task according to one embodiment of the present invention.

FIG. 6A is a flowchart showing steps performed by the check_for_input procedure according to one embodiment of the present invention.

FIG. 7 is a block diagram of an exemplary computer system useful for implementing the present invention.

### DETAILED DESCRIPTION

I. Overview

The present invention is directed to a system, method and computer program product for converting Internet protocol (IP) communication data packets to inputs compatible with X.25 protocol software applications used in EMV chip card terminals, for example. The present invention is described in more detail below with reference to a preferred embodiment. This is for convenience only and is not intended to limit the application of the present invention. In fact, after reading the following description, it will be apparent to one skilled in the relevant art(s) how to implement the following invention in alternative embodiments.

II. System

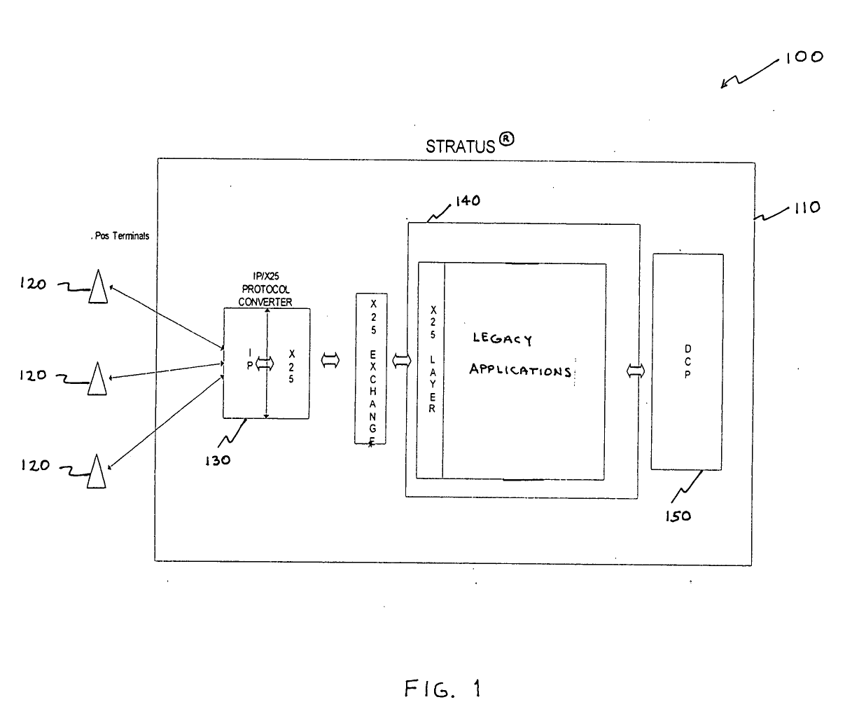

FIG. 1 is a block diagram of an exemplary system environment 100 in which the present invention, in an embodiment, would be implemented.

System 100 includes a server 110 (e.g., a STRATUS® server using the VOS operating system) connected to plural IP-enabled POS terminals 120. POS terminals 120 are connected to IP/X.25 protocol converter (gateway) 130 according to the present invention, which resides on server 110.

IP/X.25 gateway 130 converts IP protocol packets being sent from the IP-enabled POS terminals 120 into the X.25 protocol so that legacy application programs 140 on server 110 can process the data arriving in those packets, without legacy programs 140 needing to be modified to accommodate the use of IP by POS terminals 120. The packet conversion performed by IP/X.25 gateway 130 is described below.

A known backend application DCP 150 is used to transmit authorization data to a credit authorization system (not shown).

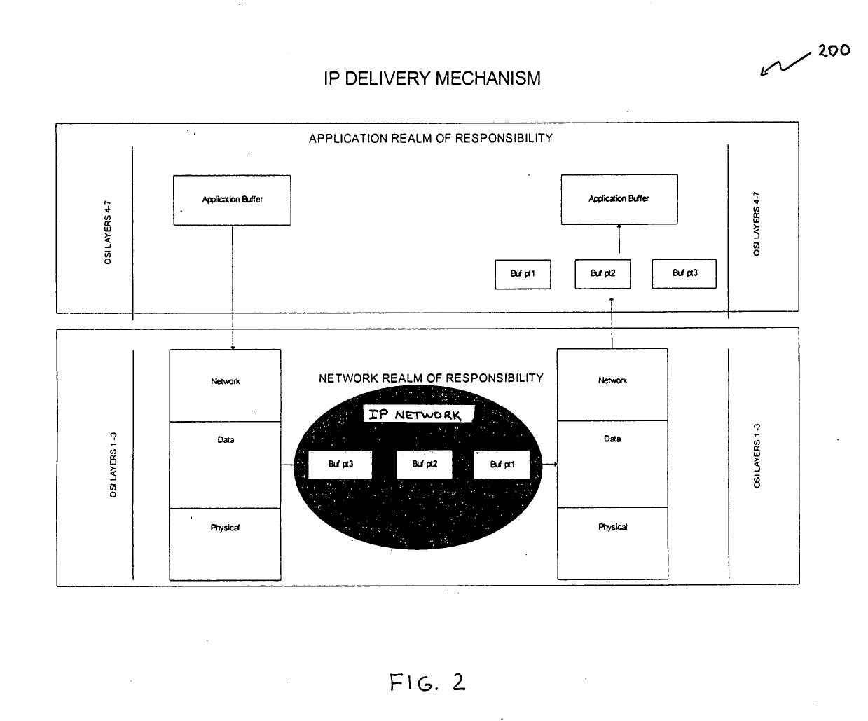

FIG. 2 is a system diagram illustrating a typical IP delivery mechanism 200 used by the POS terminals 120 shown in FIG. 1. This IP delivery mechanism 200 illustrates how an IP application buffer is delivered to the IP/X.25 gateway 130.

The Open System Interconnection (OSI) layers shown in FIGS. 2, 3, and 4, are part of a well-known networking framework for implementing protocols in seven layers and include a physical layer (OSI layer 1), a data link layer (OSI layer 2), a network layer (OSI layer 3), a transport layer (OSI layer 4), a session layer (OSI layer 5), a presentation layer (OSI layer 6), and an application layer (OSI layer 7).

The physical layer (OSI layer 1) distributes the bit stream, electrical impulse, optical or radio signals through the network at the electrical and mechanical levels. It provides the hardware means for sending and receiving data.

The data link layer (OSI layer 2) encodes and decodes data packets into bits. It furnishes transmission protocol knowledge and management and handles errors produced by the physical layer. The data link layer is divided into two sub-layers, the media access control layer (MAC sub-layer) and the logical link Control Layer (LLC sub-layer). The MAC sub-layer controls how a computer on the network gains access to the data and permission to transmit it. The LLC sub-layer controls frame synchronization, flow control, and error checking.

The network layer (OSI layer 3) provides switching and routing technologies, creating logical paths, known as virtual circuits, for transmitting data from node to node. Routing and forwarding are functions of this layer, as well as addressing, internetworking, error handling, congestion control, and packet sequencing.

The session layer (OSI layer 4) provides transparent transfer of data between end systems or hosts, and is responsible for end-to-end error recovery and flow control. The session layer ensures complete data transfer.

The presentation layer (OSI layer 5) establishes, manages, and terminates connections between applications. The session layer sets up coordinates, and terminates conversations, exchanges and dialogues between the applications at each end. The session layer deals with session and connection coordination.

The presentation layer (OSI layer 6) provides independence from differences in data representation (e.g., encryption) by translating from application to network format, and vice versa. The presentation layer works to transform data into a form that the application layer can accept.

The application layer (OSI layer 7) supports application and end-user processes. Communication partners are identified, quality of service is identified, user authentication and privacy are considered, and any constraints on data syntax are identified. Everything in this layer is application-specific.

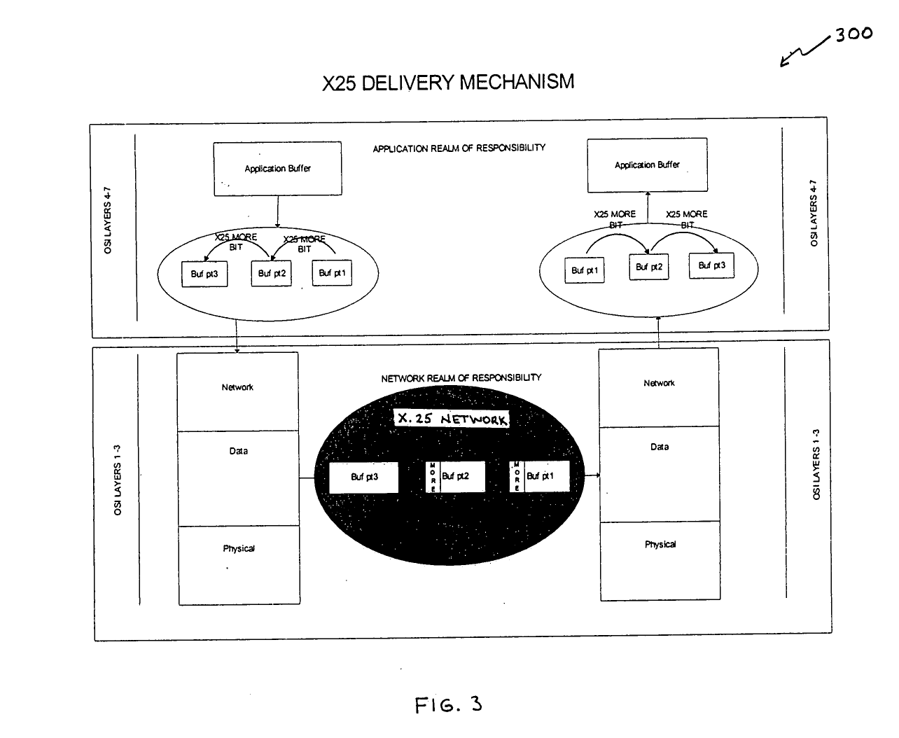

FIG. 3 is a system diagram illustrating a typical X.25 delivery mechanism 300 used to deliver the required complete application buffer to the X.25 legacy programs 140 shown in FIG. 1. As is well known, the X.25 protocol logically links packets using the X.25 More Bit.

The X.25 protocol encompasses the first three layers of the OSI seven-layered architecture described above and, because the data link layer (layer 2) checks and corrects errors for each hop all the way across the network, the X.25 protocol is robust, and so is suitable for noisy, error-prone links.

Thus, one of the largest uses of X.25 is the transfer of asynchronous data streams such as those produced by simple terminals like credit card readers and POS credit card and debit card authorization terminals.

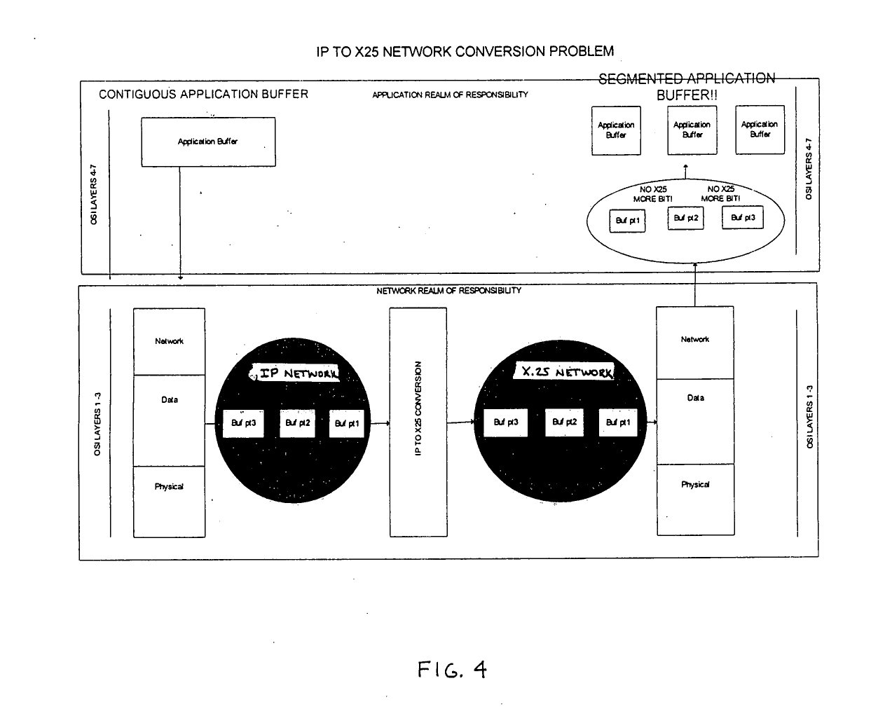

FIG. 4 is a system diagram illustrating the IP-to-X.25 conversion problem that is solved by IP/X.25 gateway 130. The problem illustrated in FIG. 4 is encountered by an application designed for data that conforms to the X.25 protocol when the IP buffer is fragmented (see below) and the X.25 protocol ends up with no X.25 More Bits to link together the packets. This problem would generally cause the application to crash.

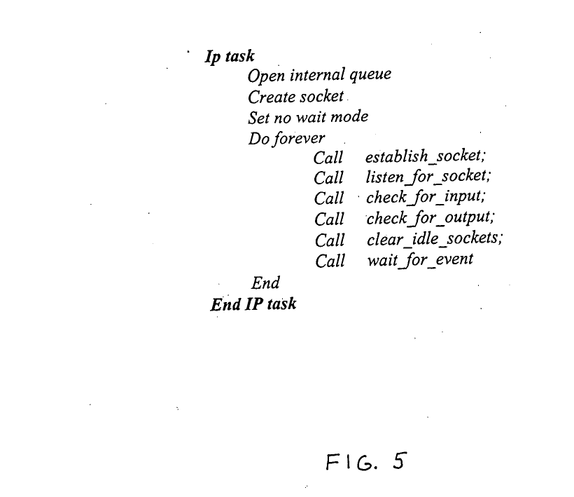

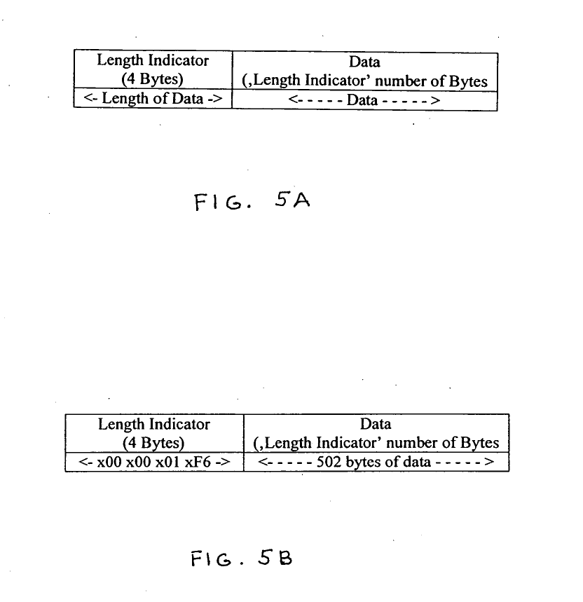

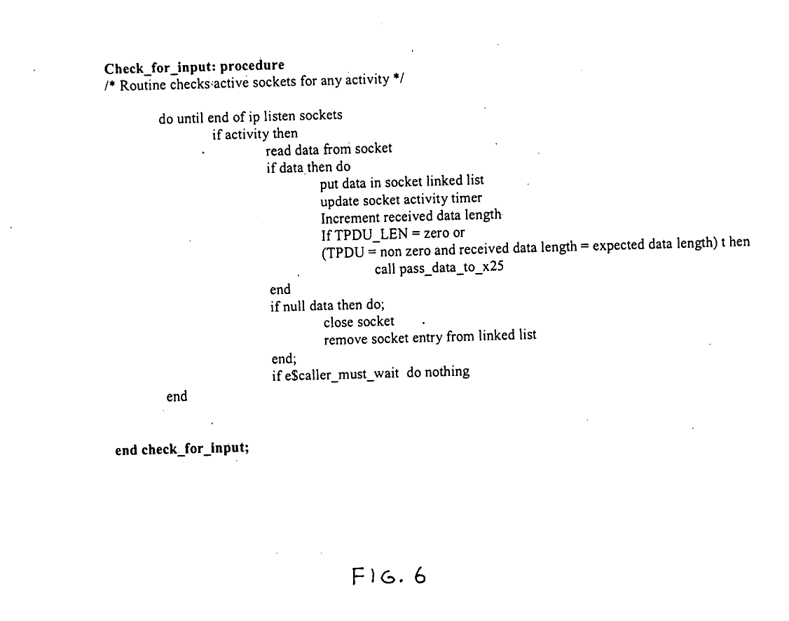

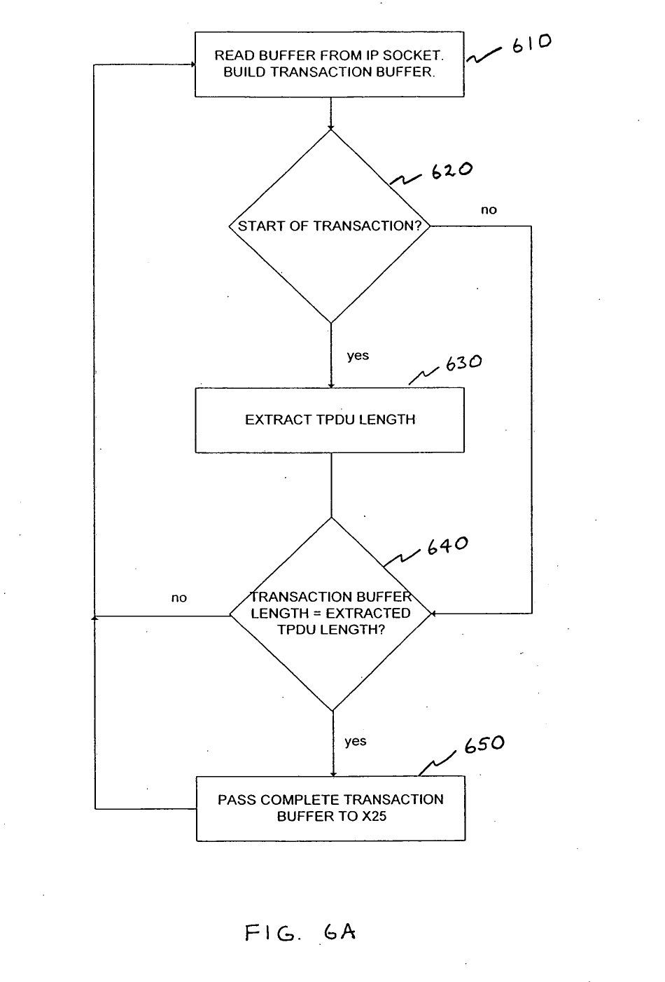

FIG. 5 is a pseudocode listing showing the main processing logic for an IP task that performs the required IP-to-X.25 conversion. The IP task logic, which is an example of part of an implementation of IP/X.25 gateway 130, operates by examining the transport layer (OSI layer 4 and above) packets for a length indicator of the IP buffer. This task is performed in the check_for_input procedure described below, and shown in FIG. 6.

An IP protocol message, as shown in FIG. 5A, starts with a 4-byte length indicator. This field defines the length of the data buffer in bytes following the length indicator. The presence of the length indicator defines the IP protocol message boundaries (e.g., the start of the message), the IP protocol being a streaming protocol based on a stream of bytes.

An example of an IP protocol message having 502 bytes of data in the buffer is shown in FIG. 5B.

The check_for_input procedure checks the length indicator of a Transportation Protocol Data Unit (TPDU) that is included as a header in an IP packet. This variable is shown in FIG. 6 as TPDU_LEN and denotes the overall data length of the IP buffer.

The IP Front End Processor (IP FEP) thus can (and does) make sure that the complete IP application buffer is received and reconstructed before passing the reconstructed buffer for processing by X.25 protocol software applications 140.

FIG. 6A is a simplified flowchart showing steps performed by the check_for_input procedure. The check_for_input procedure starts at step 610 by reading a buffer from an active IP socket, then proceeds to step 620, where it is determined whether the read buffer is the start of an IP application buffer by checking for the presence of a length indicator. The TPDU_LEN is then extracted at step 630.

The length of the read buffer is compared to the extracted TPDU_LEN at step 640, and, when the two are equal, the buffer is passed to the X.25 application at step 650. When the length of the buffer is less than the TPDU_LEN, the procedure continues to read data until a complete application buffer is reconstructed, before the buffer is passed to the X.25 application.

The processing shown in FIGS. 5, 6, and 6A forms part of IP/X.25 protocol gateway 130, and insures that a complete application buffer is forwarded to X.25 legacy programs for processing.

III. Example Implementations

The present invention or any part(s) or function(s) thereof may be implemented using hardware, software or a combination thereof and may be implemented in one or more computer systems or other processing systems. However, the manipulations performed by the present invention were often referred to in terms, such as adding or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices.

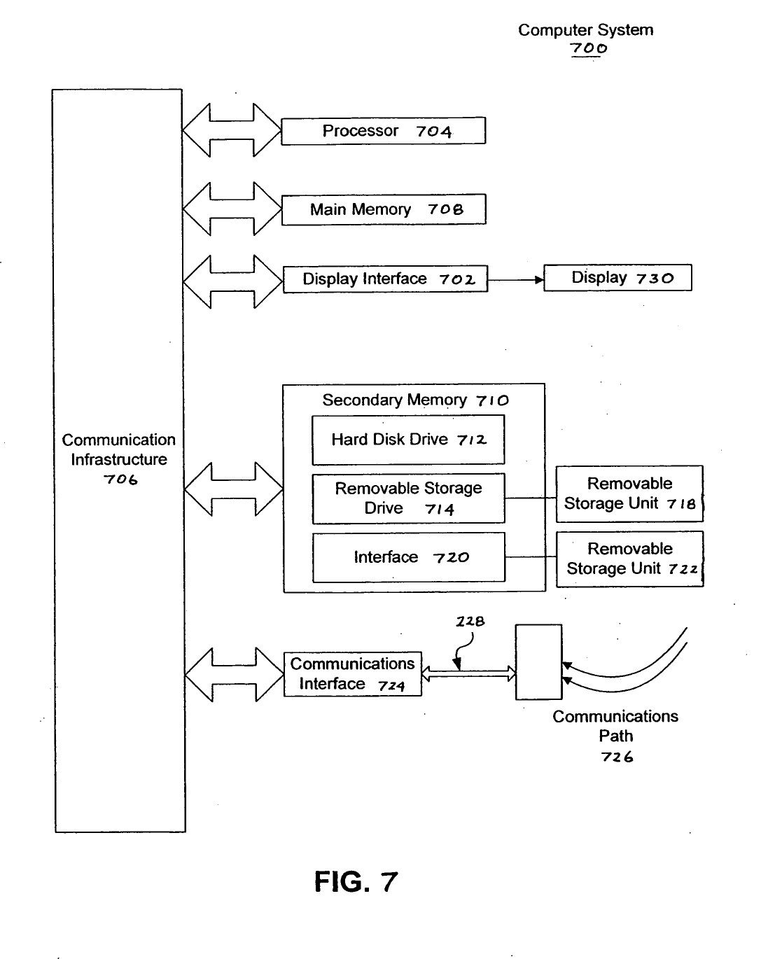

In fact, in one embodiment, the invention is directed toward one or more computer systems capable of carrying out the functionality described herein. An example of a computer system 700 is shown in FIG. 7.

The computer system 700 includes one or more processors, such as processor 704. The processor 704 is connected to a communication infrastructure 706 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 700 can include a display interface 702 that forwards graphics, text, and other data from the communication infrastructure 706 (or from a frame buffer not shown) for display on the display unit 730.

Computer system 700 also includes a main memory 708, preferably random access memory (RAM), and may also include a secondary memory 710. The secondary memory 710 may include, for example, a hard disk drive 712 and/or a removable storage drive 714, representing a floppy disk drive, a magnetic tape drive, an optical disk drive, etc. The removable storage drive 714 reads from and/or writes to a removable storage unit 718 in a well known manner. Removable storage unit 718 represents a floppy disk, magnetic tape, optical disk, etc., which is read by and written to by removable storage drive 714. As will be appreciated, the removable storage unit 718 includes a computer usable storage medium having stored therein computer software and/or data.

In alternative embodiments, secondary memory 710 may include other similar devices for allowing computer programs or other instructions to be loaded into computer system 700. Such devices may include, for example, a removable storage unit 722 and an interface 720. Examples of such may include a program cartridge and cartridge interface (such as that found in video game devices), a removable memory chip (such as an erasable programmable read only memory (EPROM), or programmable read only memory (PROM)) and associated socket, and other removable storage units 722 and interfaces 720, which allow software and data to be transferred from the removable storage unit 722 to computer system 700.

Computer system 700 may also include a communications interface 724. Communications interface 724 allows software and data to be transferred between computer system 700 and external devices. Examples of communications interface 724 may include a modem, a network interface (such as an Ethernet card), a communications port, a Personal Computer Memory Card International Association (PCMCIA) slot and card, etc. Software and data transferred via communications interface 724 are in the form of signals 728 which may be electronic, electromagnetic, optical or other signals capable of being received by communications interface 724. These signals 728 are provided to communications interface 724 via a communications path (e.g., channel) 726. This channel 726 carries signals 728 and may be implemented using wire or cable, fiber optics, a telephone line, a cellular link, a radio frequency (RF) link and other communications channels.

In this document, the terms “computer program medium” and “computer usable medium” are used to generally refer to media such as removable storage drive 714, a hard disk installed in hard disk drive 712, and signals 728. These computer program products provide software to computer system 700. The invention is directed to such computer program products.

Computer programs (also referred to as “computer control logic”) are stored in main memory 708 and/or secondary memory 710. Computer programs may also be received via communications interface 724. Such computer programs, when executed, enable computer system 700 to perform the features of the present invention, as discussed herein. In particular, the computer programs, when executed, enable processor 704 to perform the features of the present invention. Accordingly, such computer programs represent controllers of computer system 700.

In an embodiment where the invention is implemented using software, the software may be stored in a computer program product and loaded into computer system 700 using removable storage drive 714, hard drive 712 or communications interface 724. The control logic (software), when executed by processor 704, causes processor 704 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

### IV. CONCLUSION

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures and screen shots illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way. It is also to be understood that the steps and processes recited in the claims need not be performed in the order presented.

What is claimed is:

1. A method for converting Internet protocol (IP) communication data packets to inputs compatible with an X.25 protocol software application, comprising the steps of:
receiving an IP packet including a Transportation Protocol Data Unit (TPDU) header having a length indicator;
reading the length indicator;
determining a number of IP data packets required to form a complete IP application buffer based on the read length indicator;
forming the complete IP application buffer using the determined number of IP data packets; and
outputting the complete IP application buffer for processing by the X.25 protocol software application.

2. A system for converting Internet protocol (IP) communication data packets to inputs compatible with an X.25 protocol software application, comprising:
receiving means for receiving an IP packet including a Transportation Protocol Data Unit (TPDU) header having a length indicator;
reading means for reading the length indicator;
determining means for determining a number of IP data packets required to form a complete IP application buffer based on the read length indicator;
forming means for forming the complete IP application buffer using the determined number of IP data packets; and
outputting means for outputting the complete IP application buffer for processing by the X.25 protocol software application.

3. A computer program product comprising a computer usable medium having control logic stored therein for causing a computer to convert Internet protocol (IP) communication data packets to inputs compatible with an X.25 protocol software application, said control logic comprising:
first computer readable program code for causing the computer to receive an IP packet including a Transportation Protocol Data Unit (TPDU) header having a length indicator;
second computer readable program code for causing the computer to read the length indicator;
third computer readable program code for causing the computer to determine a number of IP data packets required to form a complete IP application buffer based on the read length indicator;
fourth computer readable program code for causing the computer to form the complete IP application buffer using the determined number of IP data packets; and
fifth computer readable program code for causing the computer to output the complete IP application buffer for processing by the X.25 protocol software application.
